(19) United States
(12) Patent Application Publication
(10) Pub. No.: US 2010/0205029 A1
(43) Pub. Date: Aug. 12, 2010

(54) SYSTEM FOR DIGITAL COMMERCE AND METHOD OF SECURE, AUTOMATED CREDITING OF PUBLISHERS, EDITORS, CONTENT PROVIDERS, AND AFFILIATES

(75) Inventors: Michael Asherman, Cambridge, MA (US); Steven Asherman, New York, NY (US); Arun Kumar, Bangalore (IN); Narayan Singhal, Glen Ridge, NJ (US); Andrew Pugliese, Glen Ridge, NJ (US)

Correspondence Address: DAY PITNEY LLP, 7 TIMES SQUARE, NEW YORK, NY, 10036-7311, US

(73) Assignee: CONTENT GALAXY INC.

(21) Appl. No.: 12/704,074

(22) Filed: Feb. 11, 2010

Related U.S. Application Data
(60) Provisional application No. 61/207,346, filed on Feb. 11, 2009.

(51) Int. Cl. G06Q 10/00; G06Q 30/00; G06Q 40/00

(52) U.S. Cl. 705/8

(57) ABSTRACT

The disclosure relates to a system and method of distributing digital content to authenticated users, such as on-line subscribers, wherein all interested parties, such as, but not limited to, publishers, editors, content providers, affiliates, payment processors, and service providers, are credited automatically for their contributions in such as manner as to be perceived as being fair, transparent, and resistant to abuse. The system and method may include a digital rights management system, but this is not required. The system supports a unique method of accounting that provides appropriate incentives to editors and affiliates, as well as publishers, with facilities for specifying a set of flexible parameters that enable automated payment, accounting, reporting, and administrative functions needed to support secure, subscription-based on-line publications. Such a system can be the basis for sharing revenues from subscriptions and/or advertising, or in a non-commercial context it can provide a useful, trustworthy metric for assessing the relative merit of individual contributors to a shared repository of information.

This application claims priority under 35 U.S.C. §119(e) of U.S. provisional application Ser. No. 61/207,346 filed Feb. 11, 2009, the disclosure of which is hereby incorporated by reference.

### BACKGROUND OF THE INVENTION

1. Field of the Disclosure

The present disclosure pertains to a system and method of distributing copyrighted or other digital content to authenticated users, such as on-line subscribers, wherein all interested parties are credited automatically for their contributions in such as manner as to be perceived as being fair, transparent, and resistant to abuse. Such a system can be the basis for sharing revenues from subscriptions and advertising, or it may simply provide a useful, trustworthy metric for assessing the relative popularity of individual contributors to a shared repository of information.

2. Description of the Prior Art

Creators and publishers of digital content are finding it increasingly difficult to profit from on-line sale, but not for lack of talent or interest in their material. Rather, as the interne grows, there is more competition, much of it free, and it becomes harder for a single author or publication to be seen. While e-commerce gets ever more complicated and advertising grows more profuse, many content providers have failed to receive significant revenue. Authors and artists are most aware of these problems, but ultimately everyone suffers from the lack of an efficient market for digital content, ranging from, but not limited to, videos and music to software, photographs, documents and news.

Cable television, which emerged in an environment previously dominated by free, ad-driven broadcasting, has proven people's willingness to pay for subscriptions. Likewise, despite the dominance of free, ad-driven web content, some publishers have established highly successful web-based subscription services, such as Consumer Reports Online and America's Best Colleges from U.S. News & World Report. Ongoing interest in alternative models of “software as a service” further indicates that subscription Internet services are on the upswing and far from any inherent limits.

With the growth in high-speed networking, users clamor for good material, while ever-expanding communities of bloggers and creative content producers yearn for adequate compensation. The convergence of these trends, both on the supply side and the demand side, coupled with the falling cost of the required technology, opens up the possibility of a major new avenue of micro-commerce in digital content.

A number of non-commercial, academic, and social networking sites have successfully brought together the work of many individual contributors to create valuable, free information resources. Wikipedia, MIT's Open Courseware, and YouTube are notable examples. In such systems, where there is no direct compensation to authors and editors, people's willingness to contribute their efforts depends upon recognition of the significance of their contributions.

### OBJECTS AND SUMMARY OF THE DISCLOSURE

It is therefore an object of the present disclosure to provide a method and apparatus for fairly apportioning credit, either monetary or non-monetary, to authors, editors, and other contributors to a collective body of digital content. In a non-commercial context, this would promote greater participation by contributing authors and editors, leading to improvements in the quality and quantity of content. In a commercial context, this would provide the basis for generating a revenue stream for digital content, with automated compensation to all interested parties.

The most immediate potential of the present disclosure lies in its enabling publishers to expand into the largely untapped “long tail” of the market for digital content, which is better than free, but hasn't yet reached the status of premium-priced material. The present disclosure is unique in its support of a flexible subscription model that handles input from many independent authors, artists, and editors, including provisions for automated compensation. By creating a new way for talented content creators to get paid for their work, the present system gives publishers another way of enlarging their offerings to a still wider audience of subscribers.

The present disclosure targets the broad market for premium digital content as well as the large, under-served segment for less well-known material that is “better than free”. For most authors and artists, including many with tremendous talent, there are few profitable alternatives to simply giving away their material in the hope of eventually being discovered by a major publisher. Without a business model that is profitable for this segment of content producers, a valuable resource remains largely untapped. The present disclosure offers talented creators of digital content a business model that is much more attractive than giving away their works for free, and at the same time it helps them gain the exposure they deserve.

At the low end, subscribers to the present system based on online publications pay a modest annual fee for access to a collection of content. This could be any sort of digital content: images, software, videos, music, documents, or simply informative web pages not readily obtainable from free sources. Contributing authors receive a pro-rated portion of the publication's total subscription revenue, based on the number of unique subscriber downloads or minutes of streaming of their material. (By crediting only the first download of a given item for each authenticated subscriber, the present disclosure prevents gaming the system.) Authors and affiliates also would receive commissions on each new subscription directly attributable to their content or referral.

At a higher subscription rate, premium-based publications can serve niche markets and represent more established authors and artists. Such premium publications offer a potentially lucrative, subscription-based method of selling digital content, with a number of advantages over alternative approaches. For example, the present disclosure has the flexibility to adapt to a variety of digital rights management (DRM) and watermarking schemes, but better still, the present disclosure can work effectively without requiring such additional protections.

The apparatus and method of the present disclosure are attractive to subscribers, because they gain unfettered access to a substantial body of well organized, high quality content through a single, reasonably priced financial transaction. Authors receive increased exposure, since any subscriber can download their material at no additional expense. While subscribers are not charged for individual downloads, authors are immediately credited for them. Thus each author or artist is assured of revenues that fairly reflect the popularity of his or her creations.

Advertising-driven models typically generate only token compensation to authors and artists, and there are definite limits to the profits that can be achieved by increases in advertising. On the other hand, the subscription model of the present disclosure directly promotes the creation and dissemination of valuable content, which in turn creates an increasingly attractive value proposition for subscribers.

In academic and non-commercial systems or systems that solicit user-generated content, the need for recognition of merit can be addressed by providing an authoritative measure of the popularity of each contributor's work, such as that computed by the present disclosure. Editorial participation becomes increasingly important as the amount of content grows. In addition to crediting the contributions of authors, the present disclosure credits the contributions of editors, thereby helping to promote the growth of large, non-commercial information repositories of great educational value. Efforts to develop and promote the growth of large, academic information repositories that span across multiple autonomous institutions and individual contributors are hindered by non-profit restrictions and a lack of objective measures of quality. The present disclosure provides an authoritative, non-monetary method of crediting contributions that can fulfill the essential academic purpose of grading performance. In this way the system of the present disclosure can promote greater cooperation and collaboration among diverse academic institutions and individuals, to produce better educational resources shared across a larger community of users.

### BRIEF DESCRIPTION OF THE DRAWINGS

Further objects and advantages of the disclosure will become apparent from the following description and from the accompanying drawings, wherein:

FIG. 1 is a schematic of the processing of subscriptions according to the present disclosure.

FIG. 2 is a schematic of the disbursement of credits from the compensation pool of FIG. 1.

FIG. 3 is a schematic of the relationship of the various web sites with relation to the present disclosure.

FIG. 4 is a schematic of a typical implementation of the system of the present disclosure.

FIG. 5 is a schematic of data transformation steps of the implementation of the system of FIG. 4.

FIG. 6 is an example of a single database queue pointing to multiple payload tables with different record layouts, applicable to an embodiment of the system of the present disclosure.

FIG. 7 is an example of a queue structure, further illustrating the instruction layout, applicable to an embodiment of the system of the present disclosure.

FIG. 8 is an example of an active database queue with delayed deletions, applicable to an embodiment of the system of the present disclosure.

FIG. 9 is a state diagram of state transitions of the database queue item status, applicable to an embodiment of the system of the present disclosure.

FIG. 10 is a flow diagram of high speed queuing operation, applicable to an embodiment of the system of the present disclosure.

### DETAILED DESCRIPTION OF THE PREFERRED EMBODIMENTS

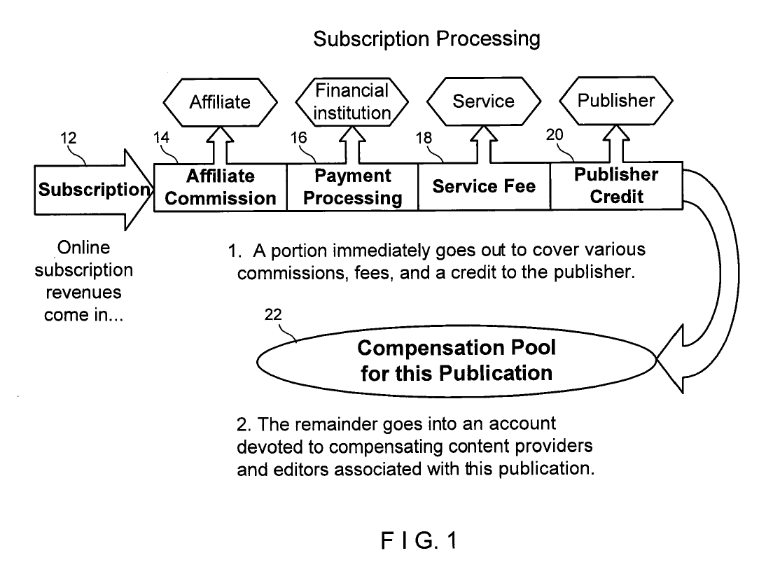

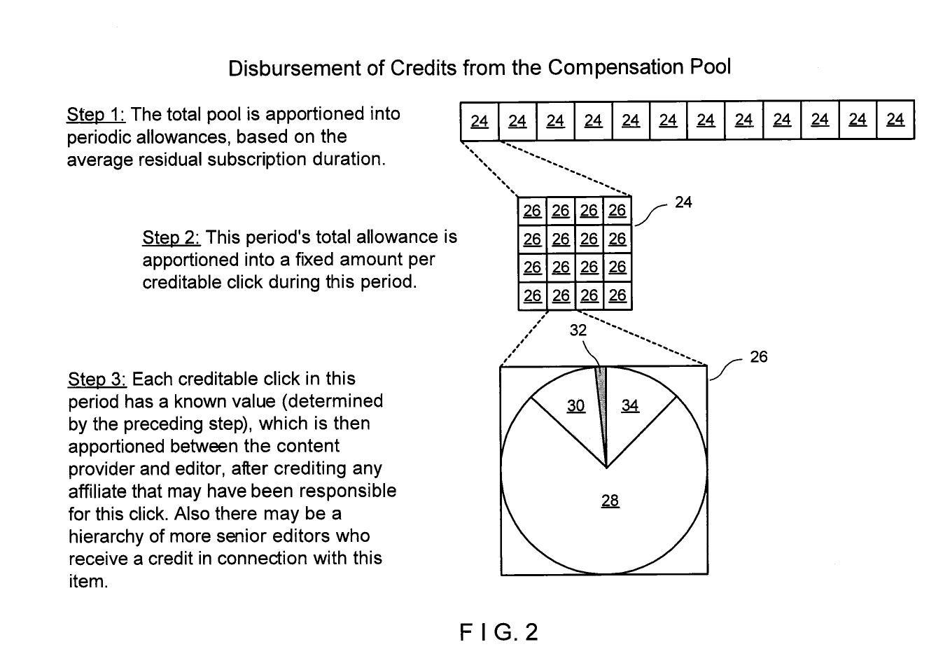

Referring now to the drawings in detail wherein like numerals indicate like elements throughout the several views, there are two stages of processing that determine how money passes through the system 10. The first stage, as shown in FIG. 1, occurs when a subscription to a specific publication is purchased from the service provider, typically through a credit card transaction made via a system-provided online form. The second stage of system financial processing, as shown in FIG. 2, occurs at regular intervals, which could be daily, weekly, monthly, or any other frequency, possibly varying from publication to publication.

As shown in FIG. 1, in the initial processing performed upon completing a subscription purchase transaction thereby generating an income stream 12, portions of the income stream 12 (gross subscription amount) immediately are disbursed or credited (as specified by pre-determined formulas) to various parties:

the affiliate, if any, entitled to receive a commission 14 on the sale of this subscription

the financial institution, which receives a fee 16 for payment processing,

the system service further receives a fee 18, which is typically an agreed-upon percentage for the publication,

the publisher, further receives a credit 20 from the net subscription amount, this credit 20 is typically determined in advance by the publisher.

The balance of the subscription, after the preceding subtractions, is credited to a system-managed pool of funds 22 devoted to compensating producers of that publication. For each publication, such an account is used in a periodic, post-subscription stage of financial processing, when the system credits funds to the associated content providers, editors, and affiliates.

In other words, the first step illustrated in FIG. 1 determines the amount to be disbursed from the pool to cover usage in the current accounting period. This is the total pool amount divided by the average residual duration of subscriptions to this publication. In other words, the amount disbursed will be approximately the pro-rated amount from subscriptions for the duration of the accounting period. For example, if the average subscription has six months remaining and the accounting period is monthly, one sixth of the total pool amount would be disbursed for this month.

FIG. 2 illustrates how credits from compensation pool 22 are allocated. The first step is that the compensation pool 22 is broken up into periodic allowances 24, based on the average residual subscription duration. Each periodic allowance 24 is then apportioned into a fixed amount 26 per “creditable click” (or other unit of on-line or similar access). Each “creditable click” in this period has a known value, i.e. the fixed amount 26, which is then apportioned between the content provider (or author) 28 and the editor 30 (which may further include a hierarchy of editors, such as the illustrated senior editor 32), as well as any affiliate 34 that may have been instrumental in generating this click. The affiliate 34 may be paid a predetermined amount, according to a contractual or similar agreement, with the remaining portion of the fixed amount 26 being divided proportionally amongst the various parties 28, 30, 32, or the affiliate 34 may receive a predetermined proportion of fixed amount.

In other words, in order to compute the amounts to be credited that are based on usage statistics, the system 10 performs the following sequence of steps (for each publication):

1. determine the portion of the compensation pool 22 that applies to this accounting period
2. determine value of each creditable click for this period, in dollars or other appropriate units
3. apportion each credit among content provider, editor(s), and possibly an affiliate

In the second step illustrated in FIG. 2, after computing the amount to be disbursed, the system determines the value of each creditable click for this period. This is calculated by dividing the amount to be disbursed by the total number of creditable clicks for this publication in this period. That is, each creditable click has the same value within a given publication and accounting period, and this value is guaranteed to result in disbursing exactly the intended fraction of the total available pool amount.

For each creditable click, there is a particular item of content involved, with an associated content provider (author/artist) and an associated editor. That editor may, in turn, be subordinate to a more senior editor, and so on. Also there may be an affiliate to be credited for this specific download (as distinct from an affiliate tied to a new subscription). The present system calculates the apportionment of credit to each of these parties according to a pre-determined formula for this publication. For example, the breakdown could be 10% to the affiliate, 80% to the author, 9% to the first editor, and 1% to the senior editor, or if there is no affiliate or senior editor, the breakdown might be 90% to the author and 10% to the editor. The only absolute constraint is that the total of these portions must add up to 100%.

It should be noted that the preceding algorithm cannot exhaust the compensation pool 22 prematurely, but it could leave some excess balance of undisbursed funds in the pool, due to non-uniformity of actual usage patterns. The possibility of large daily variations in the value of a click can be diminished by increasing the duration of the accounting period, e.g. by using weekly instead of daily accounting. In any case, the logic of the present system tends to be self correcting: any unused pool amount simply can be carried forward, correspondingly increasing the value of future credits.

The subscription processing of the basic model of system 10 typically permits unrestricted subscriber access to the full range of content in a given publication, with or without a digital rights management system. Compensation in system 10 is based upon the concept of a “creditable click”, which is defined as the first access to a given piece of content by a given subscriber, within the subscription period. Therefore, any additional accesses to the same piece of content by the same subscriber within the same subscription period are not credited, and there is therefore a maximum possible number of creditable clicks, which is typically equal to the number of subscribers times the number of content items.

The characteristic of crediting only the first download, per item, per user, eliminates an avenue of potential abuse, while establishing a reasonable basis for rewarding those who produced the most popular content. The system 10 also typically supports streaming media and optional parameters for placing limits on number of downloads and the bandwidth a subscriber can use. Additionally, other embodiments of system 10 may take download size into account and similarly may treat repeat downloads as creditable.

The basic system deals with content that typically would be downloaded as a single, relatively small file, image, or document, possibly to be saved and used again from the user's own computer. For large videos and high-quality music, a further embodiment of the present system 10 would use streaming, where the content is “viewed” as it is retrieved through an Internet connection, without making a permanent copy of the entire file on the user's computer. With streamed access, the system 10 would typically use a somewhat different formula for compensation from the basic model described above.

Where the basic model computes the value of each “creditable click” for the current accounting period, this alternative embodiment would employ computation of the value of each minute or megabyte of streaming within this accounting period. That is, by dividing the total pool allocation for this period by the total number of streaming megabytes or minutes in this period, the credit value per unit of activity is obtained. For each viewing of an item of content, the amount of such activity in this period is multiplied by the credit amount per unit, obtaining the number of actual amount (dollars or other units) to be credited for this piece of activity. The further apportionment between author/editor(s)/affiliate is the same as before.

In addition to handling income from subscriptions, the basic system model can be extended straightforwardly to support similar processing of advertising revenues. Pages containing advertisements would be associated with formulas, varying from page to page, for apportioning the advertising revenues from each page to various responsible parties, including publishers, editors, and compensation pools 22 for specific publications. In this way, the basic logic for compensating content providers would function as intended, without alteration. In other words, the net effect of adding support for advertising would be to increase the value of whatever credits would have been obtained solely from subscriptions.

Additionally, it is envisioned that the model can be applied to the allocation of non-monetary credits, which are used to provide an assessment of merit attributable to each of the contributors to a collective body of digital work. Such non-monetary credits initially could be allocated to a publication's compensation pool in accordance with the number and duration of subscriptions to that publication. For example each subscription year might contribute 100 credits to the pool. For grant-funded, non-profit publications, the number of credits allocated to the compensation pool could be determined by allocating a specified number of credits to the compensation pool for each dollar granted. Whether or not credits have any monetary value, all other aspects of processing by the system 10 operate in the same way: the record of authenticated usage by subscribers determines the proportional distribution of credits to authors and editors whose material is used.

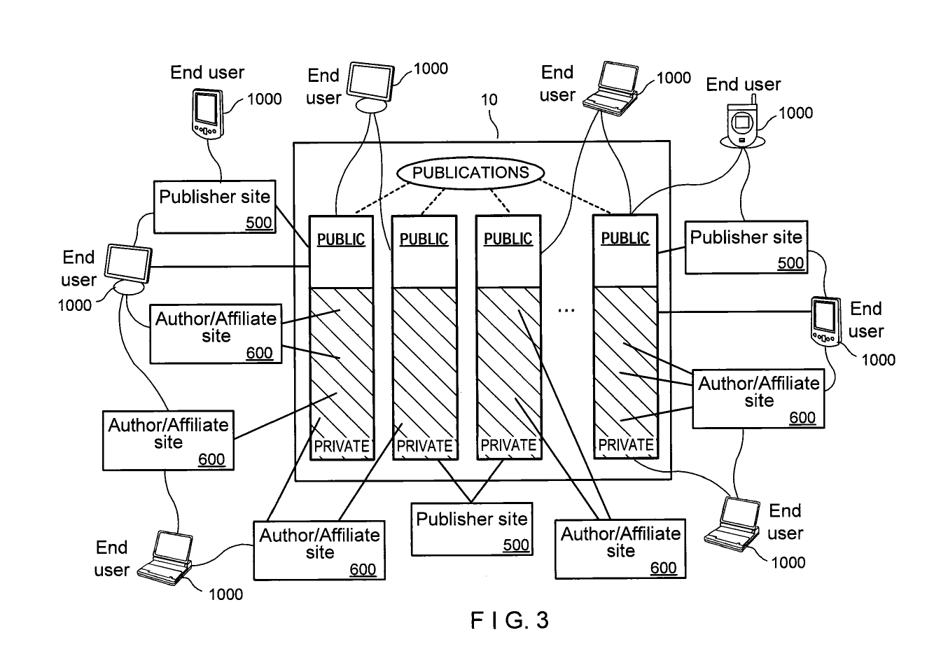

As seen in FIG. 3, the resulting system 10 allows various end users (or subscribers) 1000, using various digital devices, to access publisher sites 500 or author affiliate sites 600, all of which are in communication with system 10, in order to purchase or otherwise have access to all types of digital content.

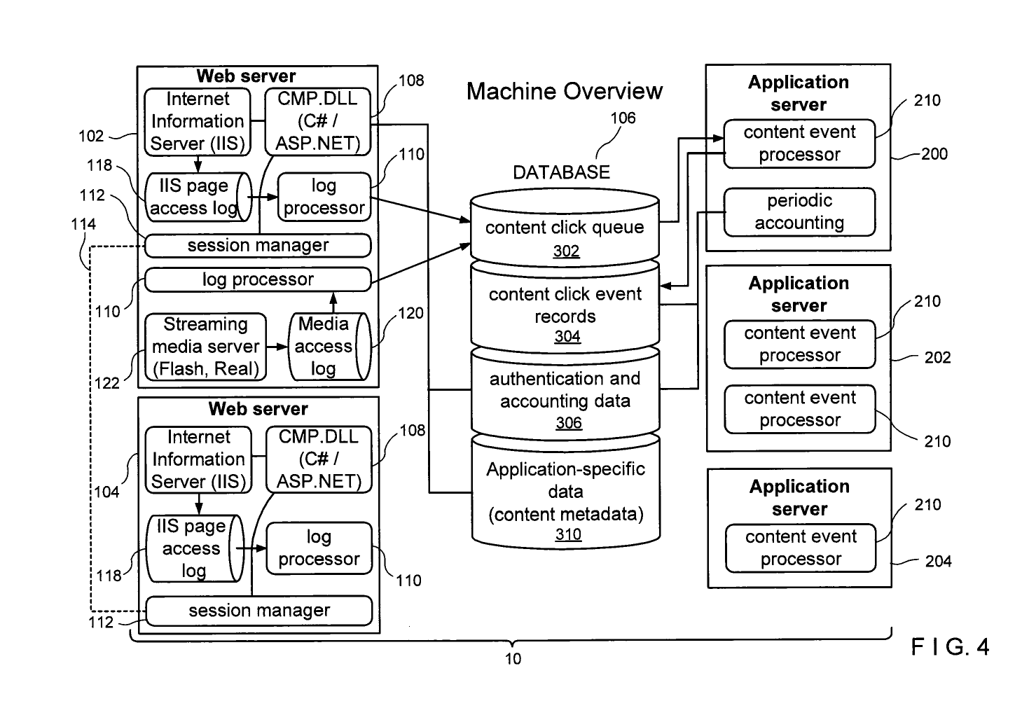

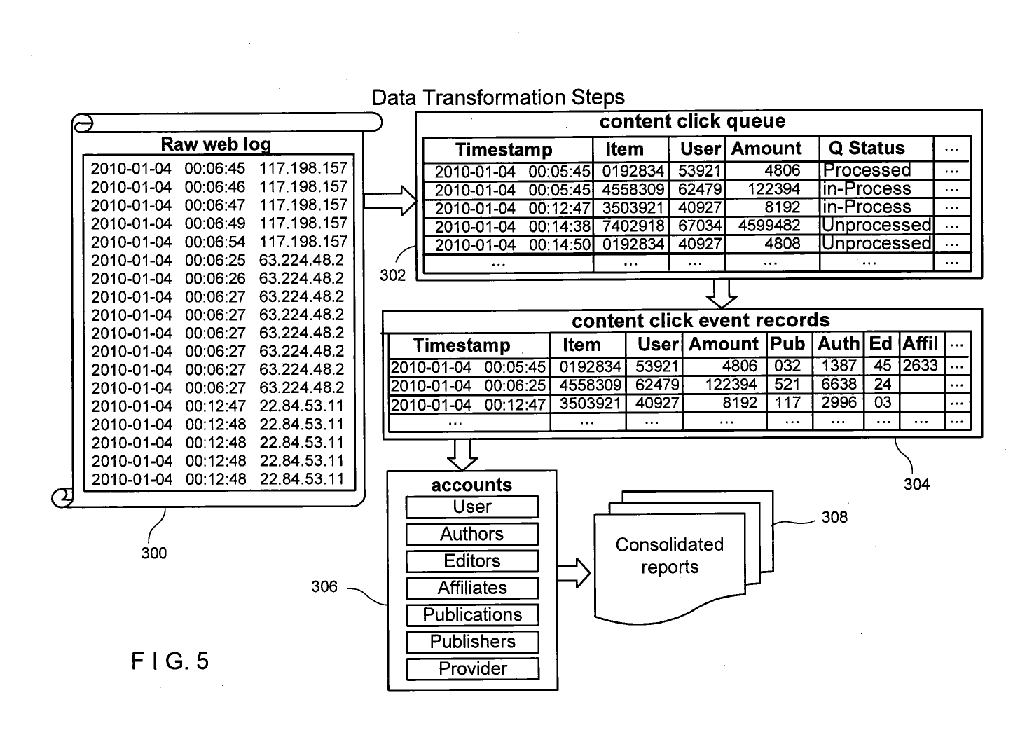

FIGS. 4 and 5 illustrate a typical implementation of system 10. This implementation of system 10 can incorporate the apparatus and method disclosed in Published U.S. Patent Application No. 2008/0263106 A1, entitled “Database Queuing and Computing” published on Oct. 23, 2008, the contents of which are hereby incorporated by reference.

The system 10 comprises various types and configurations of server computers using software and data structures to support the model of subscription-based micro-commerce. Web servers 102, 104 are connected through a local area network (LAN) to a shared relational database 106 running on a cluster of database servers, which also is connected through the LAN to a number of application server machines 200, 202, 204. While three application server machines are illustrated, a greater or lesser number is possible. The modular design provides high performance and scalability with commodity hardware and standard systems software. For example, the system 10 has been implemented in a Windows Server/IIS/SQL Server environment.

The job of the system 10 is to serve digital content to users who have subscribed to virtual publications, to process their “content clicks”, to divide up the subscription revenues according to custom formulas, and provide real time reporting and verification of activity and revenues. As shown in FIG. 4, a Content Click Event record in table 304, as derived from one or more records in the content click queue 302, as derived from one or more lines of a raw page access log 118 or streaming media access log 120, represents a click on a “Content URL”, which may be embedded in an ordinary web page. The Content URL is a standard web URL or URI that represents a file or set of files with some of a publication's protected content. Additional information for identifying what web page generated the content click is included as query parameters in the Content URL.

The system 10 performs a series of data transformations, starting from the raw text logs 300 (web page access logs 118 and streaming media access logs 120) produced on a collection of web servers, and culminating in a set of consolidated reports 308 in accordance with the various accounts 306 and the final distribution of credits to various parties according to the system's model of accounting. This provides the basis for an automated system of fair compensation or recognition of merit, based on usage by authenticated subscribers.

Many of the web server machines, in addition to running standard web server software, such as IIS (Internet Information Server), run one or more types of streaming media server software, for example, but not limited to, Adobe Flash Media Server or RealVideo streaming server. Each of these types of server software typically generates a plain text log file, including numerous details about every page access or increment of streaming activity that occurred. The format of server logs is typically flexible, well documented, and standardized by the World Wide Web Consortium (W3C).

Each web server machine 102, 104 also runs an instance of the CMP.DLL software component 108, typically written in C# and ASP.NET, for dynamic generation of web pages, downloadable documents, images, software, and video and sound streams. The primary function of CMP.DLL 108 is to retrieve a piece of content given its unique Item ID. The web server machines 102, 104 host the pages for the web site.

A call to the functions or subroutines of CMP.DLL 108 downloads a file with protected content. CMP.DLL 108 also supports subroutines for providing access to streaming content, possibly through a browser widget for the type of protected content being streamed (video or sound) that is appropriate for the client device (PC, mobile phone, etc.) Corresponding versions of these functions or subroutines also provide a low-level programmer's interface (API) for escaping default behaviors, such as automatically displaying the returned content in the user's browser or displaying a logon dialog as the method of authentication.

These functions or subroutines also support optional query parameters for specifying an affiliate numeric code or character ID and attaching an annotation (e.g. for A/B testing and categorizing the pages where the click originated). Useful information that is known to CMP.DLL 108, for example the user ID, or the fact that a particular request triggered a subscription purchase, is incorporated into the web log, so this can later be extracted by the Log Processor 110. The system's subscription model typically requires user authentication, and this is handled by CMP.DLL 108 through an initial login dialog, using session cookies to keep track of an already logged-in user.

As a further refinement, the system session manager 112 provides a high-speed mechanism for detecting and preventing multiple concurrent logins of a single user on different machines. The system session managers 112 running on separate web servers 112 use a direct channel of communication 114 (typically through TCP/IP) to maintain a global, in-memory list of active user sessions. If a user is already logged in on another machine (such as 102 or 104), that session will automatically be terminated (if it hasn't already timed out) when the same user logs in on a different machine. This protects against the abuse of illegally sharing registered user credentials (user names and passwords).

For each web server page access log 118 or streaming media access log 120, there is a Log Processor 110 running on the web server 102, 104. The log processor 110 captures information from the web log as quickly and unobtrusively as possible, passing selected information along for further processing, in the content click queue 302 (see FIG. 5).

The log processor 110 is a background process that stores its state in the database and regularly reads newly added log items and adds them into a content click queue 302. A single content click queue is sufficient 302, but content click queues 302 can be added to the system 10 as volume or special case handling arises. By keeping track of the log file last read, the byte offset into the log file, and the currently active log file format, the log processor 110 can proceed efficiently through the log files while guaranteeing that no content clicks get lost.

The log processors 110 take advantage of an accounting model that permits a high degree of parallel processing. There is no rigid order in which individual content clicks must be processed, so long as the processing for the period in question has completed when the final accounting is done. This could be daily, weekly, or monthly—in the meantime, log processing can be distributed across a large number of concurrent threads, processes, and servers.

Because web logs 118, 120 can grow very rapidly under heavy server load, it is important that the log processor 110 keep up with its job without over-burdening the web servers 102, 104. It is also important that the processing of web logs 118, 120 be highly reliable and resistant to failures, because the information generated may ultimately determine monetary compensation. In database terminology, this means that actions upon the content click queue 302 typically must be “transactional”.

In order to achieve the desired high performance and recoverability, the log processors 110 employ multiple threads to write to the content click queue 302. A single log reader thread for each log is sufficient, and this simplifies the design. The writer threads each must execute a transaction in writing to the queue, but the cost of such transactions can be minimized by keeping them small and localized.

To assist in achieving high performance and scalability, content click queues 302 are implemented using a database queuing method and apparatus that supports large-scale, reliable service-oriented architecture, as described in the above-identified Published U.S. Patent Application No. 2008/0263106 A1.

The Log Processor 110 adds (“pushes”) content click information into a content click queue 302 as a way to request a unit of work. The queue 302 is a database table with records that point to other records in other tables. Entries are read and removed (“popped”) from the queue by application servers 200, 202, 204 as the work is completed. These servers 200, 202, 204 pick up the content click information in first-in-first-out order and process it, creating and generating output to content click event records 304. Once this processing has been done, the corresponding queue records are flagged as having been processed. Processed items in the content click queue and their associated data are periodically deleted, as they are no longer needed. Database-oriented queuing takes advantage of database strengths such as indexing, synchronization, transaction processing, reliability, and recovery features.

In order to minimize the burden on web servers 102, 104, the bulk of the accounting job is handled by a separate, adjustable pool of application servers 200, 202, 204. The main task of these application servers is to run one or more instances of the content event processors 210. Less frequently, the application servers may run periodic accounting functions.

The content event processors 210 do the processing required to remove an item from the content click queue 302 and generate corresponding information in the content click event records 304. The object of this processing is to determine all of the quantities and identifiers needed to properly credit this increment of download or streaming activity. Some queue items can simply be discarded, and some accumulated into existing content click event records.

Some information is directly captured in the web page access logs 118 and media access logs 120 and transferred to the content click queue 302, and some data is derived from that information, in combination with administrative/accounting data 306 or metadata 310. Such additional steps as affiliate code validation, identification of the senior editor, and other accounting requirements are handled by the content event processors 210. The end result will be a content click event table (see 304, FIG. 5) sufficiently detailed to enable complete determination of all affected accounts through simple SQL queries against table 304 in conjunction with related accounting data and metadata, consolidating these individual content click events into useful aggregations.

The content event processor 210 is responsible for setting the most important content click result codes stored in the content click event records 304:

“Paid click”: Successful click by a paying subscriber where no click already exists for this subscriber for this content item and where the click date is greater than the subscription's start date. A new paid click can occur for the same subscriber each time his subscription is renewed if he downloads or streams the content item again. Content providers, editors, and affiliates (i.e., those who host websites instrumental in the transactions) receive compensation for paid clicks, and the content click event record 304 includes a Paid Download Byte Count or a Paid Stream Duration Seconds.

“Repeat click”: Paying subscriber successfully clicks again during the subscription period. No payments are made for a Repeat click, but Repeat clicks do count against the subscription's maximum, if any, for that end user.

“Cancel or fail click”: Paying subscriber is authenticated but download does not complete successfully or user cancelled download (after launching). For streaming, a small, minimum number of seconds or less of play may have occurred (e.g. because the initial frame was downloaded, but the user didn't press Play).

On the other hand, some of the less important Content Click Result codes do not require determination by the Content Event Processor, because they will have already been handled by CMP.DLL 108. These are Content Click Result codes such as:

“Non subscriber click”: Click by a non-paying user, such as a publisher, editor, content provider (for their own content), administrator, etc. (Typically, merely being an affiliate does not give one the right to freely access a publication's contents.) For non-subscribers, no distinction is made between successful or cancelled/failed clicks.

“Expired subscription”: User is authenticated but his subscription to this publication has expired, and he terminated the session without buying a subscription.

“No subscription”: User is authenticated but does not have a subscription to this publication, and he terminated the session without buying a subscription.

Web page access logs 118 and streaming media server logs 120 contain the raw information, in simple text form, from which a complete accounting must be derived. These raw web logs 300 include various standard, generic items of information, such as date/time, IP address, requested URL, number of bytes transmitted, etc. CMP.DLL 108 also causes additional items to be incorporated into these logs, for example the authenticated user id and a purchase code, if applicable. Thus CMP.DLL 108 ensures that the logs 300 contain sufficient information to support the system's accounting model. The raw web logs 300 are generated quickly, and they provide an authoritative basis for auditing, but information in this form, plain text, is unwieldy for analysis and accounting purposes.

The first stage of transformation is to analyze the log 300, and put the essential information into a more structured, tabular form, the content click queue 302, which resides in a shared database 106. A record of the content click queue corresponds roughly to a single line of text from a raw web log 300, parsed into regular columns of information. Conceptually, one can envision the content click queue 302 as a single table, but its implementation may actually entail several inter-linked tables.

As an optimization, successive log entries relating to the same user and item may be combined, so there will generally be fewer records in the content click queue 302 than the number of lines of raw log data. This is especially useful for streaming, so that multiple clicks that represent stopping and starting a single stream can be consolidated into a single content click event.

Only the information that pertains to accounting for creditable activity needs to be put into the content click queue 302. The fastest possible log processing can be done on the web server 102, 104 itself, where the log is locally accessible, but the amount of processing required for this initial transformation must be kept small, to minimize degradation of web server performance.

Once the data has entered into the content click queue 302, the further stages of transformation it must undergo can be performed entirely apart from the web servers 102, 104, by a separate group of application server computers 200, 202, 204. In this way, the accounting system can be expected to have minimal impact on web server performance, and the queue-based, parallel processing architecture assures a high degree of scalability.

Application servers 200, 202, 204 run the software of the content event processor 210 to generate content click event records 304 from entries in the content click queue 302. There will typically be fewer event records than queue items, because some will effectively be combined or discarded. Additional processing is needed in certain cases, for example to validate an affiliate id, or to determine the identity of the associated editor(s). Some items of account data, e.g. total bytes streamed by a given user, are maintained on an ongoing basis, in order to enforce usage limits and provide useful quick reporting statistics.

Periodically, the system 10 must perform a set of accounting jobs. These entail updating account information for all parties concerned, making a final determination as to the distribution of credits as of this accounting period. This information is presented to participating authors, editors, publishers, and affiliates through various summary reports 308. The ultimate outcome, in a commercial context, is that the various parties are compensated in the amount prescribed by the accounting model of the system 10. Because of the continued availability of the detailed content click event records 304, the final output (compensation to the publishers, content providers, editors, and affiliates) can be tested and audited easily.

The session manager 112 is used by the CMP.DLL 108 to prevent both multiple logons by the same user and attempts to circumvent logon. It is responsible for keeping track of the users currently doing database access on the web server machine. Security calls typically are made using Microsoft's COM interface.

The session manager 112 keeps track of database sessions. It maintains an internal list to track who's logged in for any applications on the same web server. The session manager is typically not directly connected to the central database 106, and it depends on CMP.DLL 108 or other components to perform actual database operations on database session records. Database session records track who is logged on, through what application and which web server machine.

The session manager 112 keeps database session information in memory and provides an interface for determining session validity and forcing off sessions, which may be on other machines. The session manager is responsible for communicating between different servers to ensure that a user can be forced off regardless of which web server machine is handling the session.

The session manager 112 acts as a persistent memory store, with a COM interface available to programs on the web server. The Session Manager supports four Database Session functions: RegisterDbSession, UnregisterDbSession, GetDbSessionStatCod, and ForceOffDbSession. Database sessions are uniquely identified by User ID plus Logon Date and Time, all of which are required as parameters to these function and are stored as part of the user's web session information.

The internal Database Session List has an entry for each session: Logon User ID, Logon User Date and Time, ForceOffFlag, Last Visit Date and Time, Application Time-Out Minutes. The Last Visit Date and Time are updated every time the status of the Database Session is checked. The time-out period is checked against the last visit to determine whether the session has expired. The Session Manager 112 assists CMP.DLL 108 in cleaning up database session records that have been left over because of a crash or web session time-out.

There is one database session record per logged on user. Each record includes a User ID, a Logon Date and Time, Application Name (i.e. what executable or web site), and Application Version. By displaying these records, administrators can view a list of all the users and applications logged on to the current database. The Database Session record includes addressing information identifying the web server machine through which a user is coming. Therefore, a target Session Manager can be located from the Database Session record containing a duplicate User ID. This allows one Session Manager to provide the service of sending a message to a different Session Manager that instructs it either to terminate processing immediately for that user or to set a flag to terminate processing the next time there a web request from that user. This enables the CMP.DLL on a different web server machine to do the job of forcing off the “offending” (old, invalid, extra) instance of the user at the earliest possible moment.

CMP.DLL 108 checks the session status every time a page request requiring a user logon is received. The GetDbSessionStatCod (Get Database Session Status Code) function has three return values: DbSessionStatValid, DbSessionStatNotValid (not found or timed out), and DbSessionStatForceOff. If “ForceOff” is received, the CMP.DLL 108 terminates this user session, and returns the user to the Logon form, with an appropriate message.

The above-identified apparatus and method, as disclosed in Published U.S. Patent Application No. 2008/0263106 A1, entitled “Database Queuing and Distributed Computing” published on Oct. 23, 2008, can be implemented within the system 10.

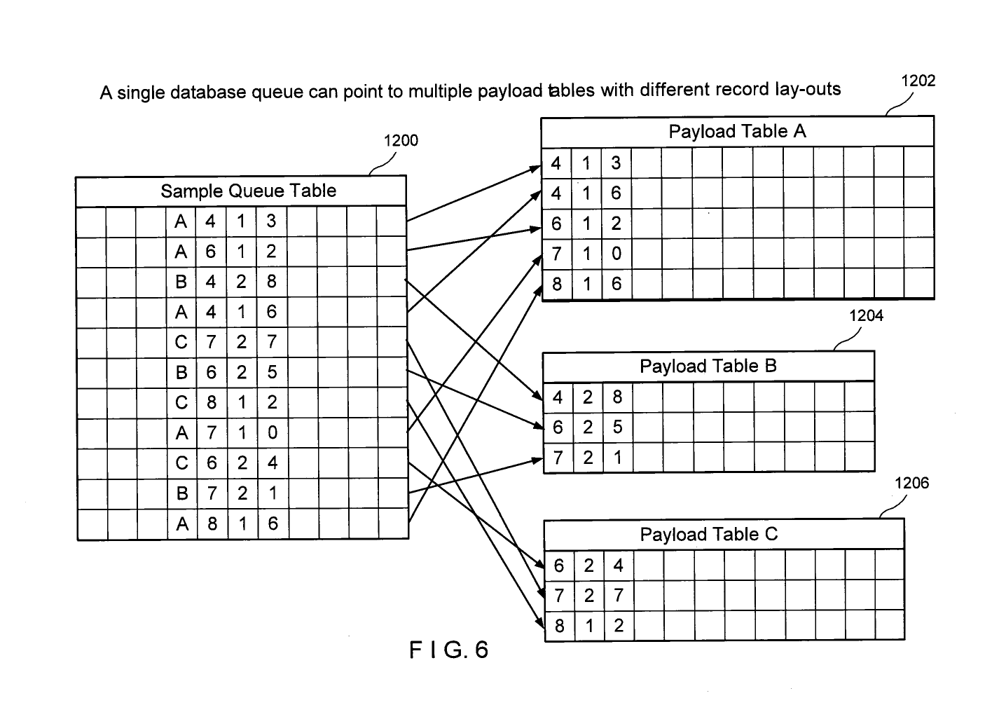

For instance, FIG. 6 illustrates a single database queue 1200 with data or index entries pointing to multiple payload tables 1202, 1204, 1206 with different record layouts (i.e., record formats, which may include differences in length) by using a flag A, B or C which points to payload tables 1202, 1204, 1206, respectively.

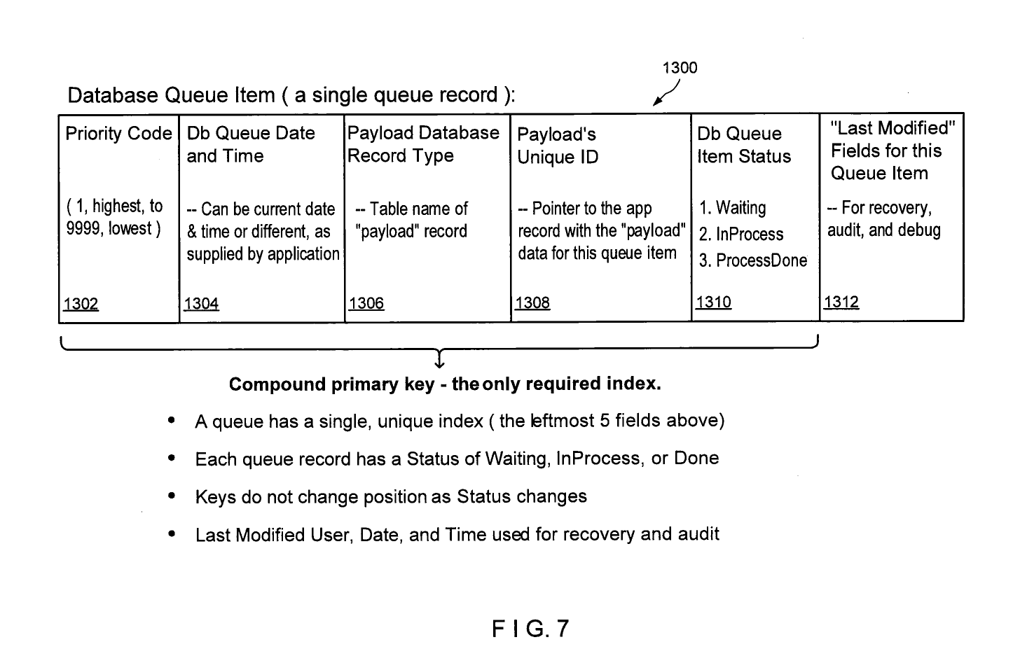

FIG. 7 illustrates a typical instruction lay-out 1300 within the distributed processing queue. A typical instruction lay-out includes priority 1302, date/time scheduled 1304, payload type 1306, payload identification 1308, status 1310 (typically waiting, in process or done) and information (typically user date and time, used for recovery and audit) regarding last modification 1312. Typically, such queues include single, unique indices (or index entries) and keys do not change position or move as status changes.

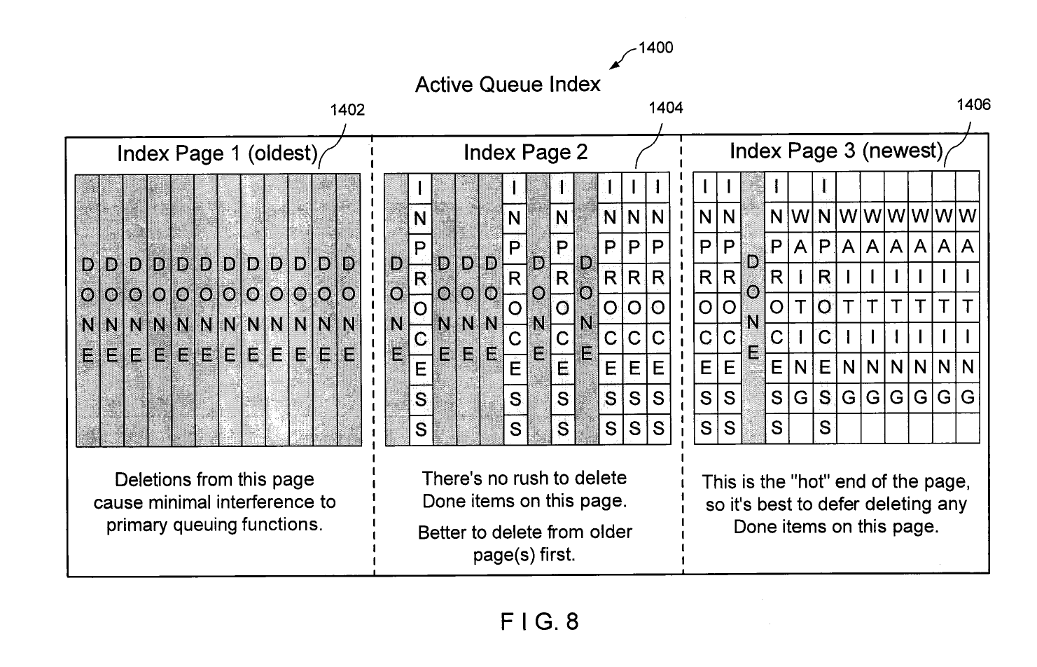

FIG. 8 illustrates an active queue's index 1400 with delayed deletions of entries. While FIG. 8 is illustrated with three index pages, first page 1402 (the oldest), second page 1404 (intermediate in age) and third page 1406 (the newest), it is envisioned that typically more than three pages employ this configuration. Deletions from the oldest index page 1402 cause minimal interference to the primary queuing functions. Deletions from the intermediate page 1404 are not urgent and it is typically preferred to make deletions from the oldest index page 1402. Similarly, it is preferable to defer making deletions from the newest index page 1406.

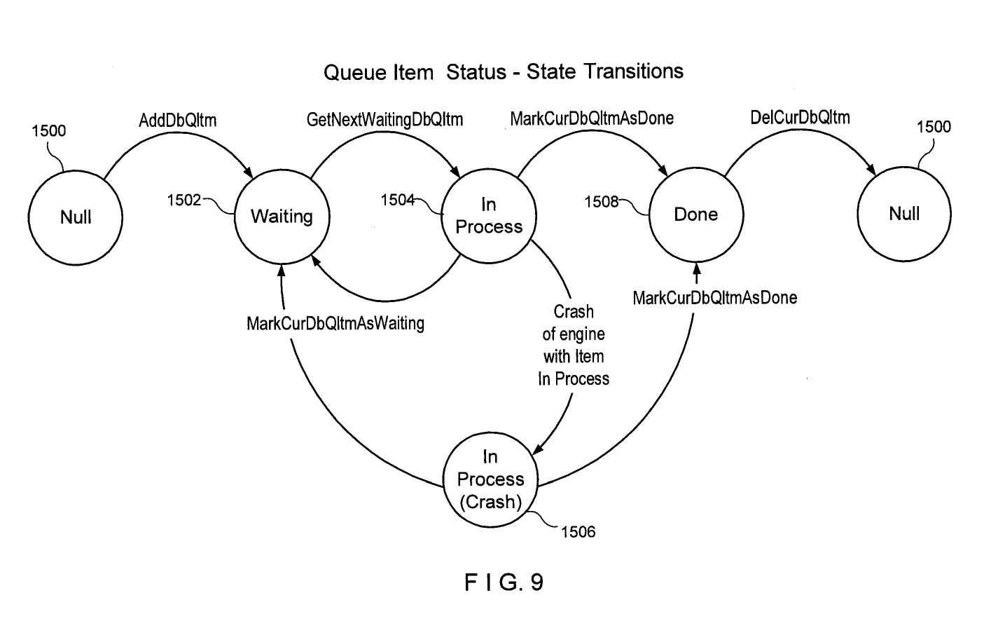

FIG. 9 illustrates the state transition of the database queue item status. Null state 1500 (illustrated for simplicity twice on FIG. 9) which can transition to the waiting state 1502. The waiting state 1502 can transition to the in-process state 1504. The in-process state can have any of three outcomes—transition back to waiting state 1502, transition to crashed (e.g. failure) in process state 1506 or the done state 1508. The done state 1508 can thereafter transition to the null state 1500.

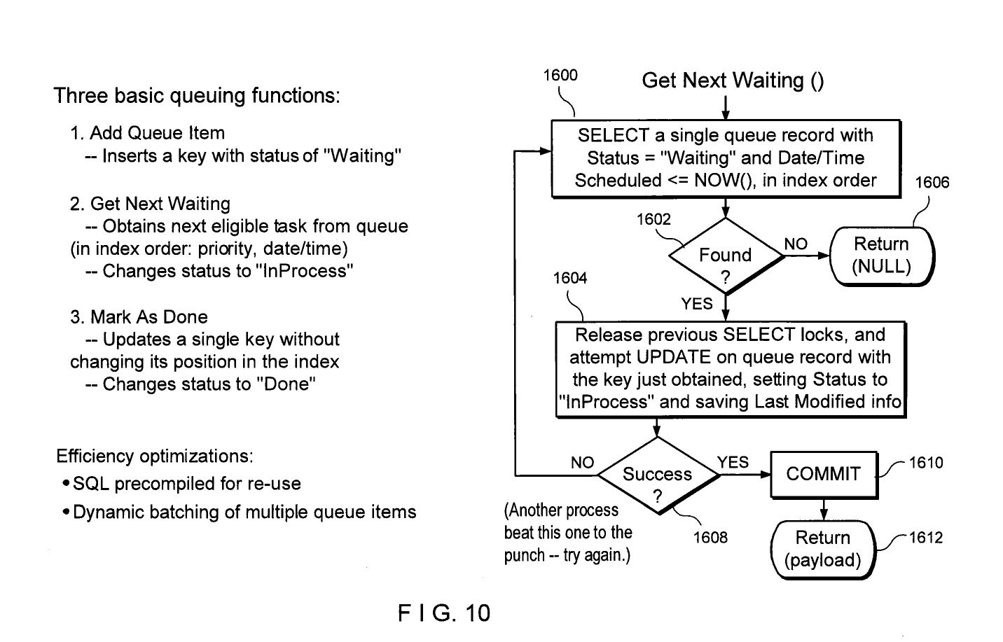

FIG. 10 illustrates the flow diagram of a high speed queuing operation, applicable to an embodiment of the system 10 of the present disclosure. In block 1600, a single queue record or task is selected. If this queue record is found, as determined by decision block 1602, then in block 1604, the previous select locks are released and an update on the queue record with the key obtained is attempted, changing the status to “in process” (see state 1504 in FIG. 9) and saving the information regarding last modification (see column 1312 in FIG. 7). If this queue record is not found, as determined by decision block 1602, then the request is returned as null in block 1606.

Thus the several aforementioned objects and advantages are most effectively attained. Although preferred embodiments of the invention have been disclosed and described in detail herein, it should be understood that this invention is in no sense limited thereby and its scope is to be determined by that of the appended claims.

What is claimed is:

1. A method for allocating an income stream derived from on-line subscriptions from authenticated users, comprising the steps of
receiving an income stream in return for the on-line subscriptions;
monitoring and recording usage by authenticated users;
allocating a first portion of the income stream to a first plurality of parties;
allocating a second portion of the income stream to a compensation pool;
periodically apportioning the compensation pool into periodic allowances;
apportioning the periodic allowances into compensation amounts corresponding to the usage received in return for the on-line subscriptions; and
allocating the compensation amounts to a second plurality of parties.

2. The method of claim 1 wherein the usage in the step of apportioning is with respect to unique downloads.

3. The method of claim 2 further including means for limiting a size of total downloads by an authenticated user.

4. The method of claim 1 wherein the usage in the step of apportioning is with respect to extent of time of data streaming.

5. The method of claim 4 further including means for limiting a total time of data streaming by an authenticated user.

6. The method of claim 1 wherein the step of monitoring and recording usage by authenticated users is done by a plurality of processors operating in parallel.

7. The method of claim 1 wherein a means is provided for preventing multiple simultaneous log-ins by a single authenticated user.

8. The method of claim 1 further including the step of compensating the first plurality of parties in accordance with the step of allocating a first portion of the income stream.

9. The method of claim 8 further including the step of compensation the second plurality of parties in accordance with the step of allocating the compensation amounts.

10. The method of claim 8 wherein the first plurality of parties includes affiliates.

11. The method of claim 8 wherein the first plurality of parties includes financial institutions.

12. The method of claim 8 wherein the first plurality of parties includes the proprietor of the method.

13. The method of claim 8 wherein the first plurality of parties includes publishers providing material for the transactions.

14. The method of claim 9 wherein the second plurality of parties includes authors of the material for the transactions.

15. The method of claim 9 wherein the second plurality of parties includes editors of the material for the transactions.

16. The method of claim 9 wherein the second plurality of parties includes affiliates who host websites instrumental in the transactions.

17. A method for allocating an income stream derived from on-line subscriptions, comprising the steps of:
receiving an income stream in return for the on-line subscriptions;
monitoring and recording usage by authenticated users;
allocating a first portion of the income stream to a first plurality of parties;
allocating a second portion of the income stream to a compensation pool;
generating data entries corresponding to each usage by an authenticated user received in return for the on-line subscriptions, wherein the data entries are stored in a queue, wherein the queue contains a plurality of index entries in an index for ordering a corresponding plurality of tasks;
periodically apportioning the compensation pool into periodic allowances;
apportioning the periodic allowances into compensation amounts corresponding to the usage received in return for the on-line subscriptions; and
allocating the compensation amounts to a second plurality of parties.

18. The method of claim 17 wherein the index entries are not moved within the queue during execution of the corresponding independent task.

19. The method of claim 17 wherein the usage in the step of apportioning is with respect to unique downloads.

20. The method of claim 19 further including means for limiting a size of total downloads by an authenticated user.

21. The method of claim 17 wherein the usage in the step of apportioning is with respect to extent of time of data streaming.

22. The method of claim 21 further including means for limiting a total time of data streaming by an authenticated user.

23. The method of claim 17 wherein the step of monitoring and recording usage by authenticated users is done by a plurality of processors operating in parallel.

24. The method of claim 17 wherein a means is provided for preventing multiple simultaneous log-ins by a single authenticated user.

25. The method of claim 17 further including the step of compensating the first plurality of parties in accordance with the step of allocating a first portion of the income stream.

26. The method of claim 25 further including the step of compensation the second plurality of parties in accordance with the step of allocating the compensation amounts.

27. The method of claim 25 wherein the first plurality of parties includes affiliates.

28. The method of claim 25 wherein the first plurality of parties includes financial institutions.

29. The method of claim 25 wherein the first plurality of parties includes the proprietor of the method.

30. The method of claim 25 wherein the first plurality of parties includes publishers providing material for the transactions.

31. The method of claim 26 wherein the second plurality of parties includes authors of the material for the transactions.

32. The method of claim 26 wherein the second plurality of parties includes editors of the material for the transactions.

33. The method of claim 26 wherein the second plurality of parties includes affiliates who host websites instrumental in the transactions.

34. A method for assessing the relative merit of a plurality of authors and editors contributing to a collective body of digital content, comprising the steps of:
establishing one or more online publications through the contributions of a plurality of authors and editors;
registering a plurality of users as subscribers to one or more of these publications;
monitoring and recording authenticated usage of the digital content by the users;
allocating non-monetary units of credit to a compensation pool associated with each online publication;
periodically apportioning each compensation pool into periodic allowances;
apportioning the periodic allowances into credits to individual contributors, corresponding to the usage received by authenticated users; and
allocating those credits to the total score of each of the authors and editors involved.

35. The method of claim 34 wherein the usage in the step of apportioning is with respect to unique downloads.

36. The method of claim 35 further including means for limiting a size of total downloads by an authenticated user.

37. The method of claim 34 wherein the usage in the step of apportioning is with respect to extent of time of data streaming.

38. The method of claim 37 further including means for limiting a total time of data streaming by an authenticated user.

39. The method of claim 34 wherein the step of monitoring and recording usage by authenticated users is done by a plurality of processors operating in parallel.

40. The method of claim 39 further including the step of recording of usage data entries in a queue, wherein the queue contains a plurality of index entries in an index for ordering a corresponding plurality of tasks.

41. The method of claim 40 wherein the index entries are not moved within the queue during execution of the corresponding independent task.

42. The method of claim 34 wherein a means is provided for preventing multiple simultaneous log-ins by a single authenticated user.

43. The method of claim 34 wherein a formulaic apportionment is specified for dividing credits between authors and editors.

44. The method of claim 43 further including provisions for dividing credits among a hierarchy of editors.
